(19) United States
(12) Patent Application Publication
(10) Pub. No.: US 2011/0268434 A1
(43) Pub. Date: Nov. 3, 2011

(54) Lens barrel retention systems of a camera module

(75) Inventors: Horst Knoedgen, Munich (DE); Ernst Schworm, Munich (DE); Gabriel Bartenschlager, Kirchheim (DE)

(73) Assignee: Digital Imaging Systems GmbH

(21) Appl. No.: 12/799,602

(22) Filed: Apr. 28, 2010

(51) Int. Cl. G03B 17/00

(52) U.S. Cl. 396/439

(57) ABSTRACT

Systems and methods to achieve an auto-focus camera module having a retention system with low friction have been disclosed. A magnetic retention system holds the carrier of the camera module, the ball bearings, and the movable lens barrel together. In case of a major mechanical shock the force of the magnetic retention system may not be sufficient to hold the parts together. Therefore a hook, which is deployed on a fixed part of the carrier of the camera module, is introduced in order to hold the parts together when a mechanical shock occurs. The hook does only engage in the movable lens barrel in a shock condition, the hook does not touch the lens barrel under normal operation conditions, hence not causing any friction if no shock occurs.

### RELATED APPLICATIONS

This application is related to the following US patent applications:

DI09-003/004, titled “Camera Module having a low-friction movable lens”, Ser. No. 12/661,752, filing date Mar. 23, 2010,

DI09-021, titled “Stabilized Ball Bearings for camera lenses”, Ser. No. 12/660,780, filing date Mar. 5, 2010,

DI09-007, titled “Twin-actuator configuration for a camera module”, Ser. No. 12/661,755, filing date Mar. 23, 2010,

DI09-012, titled “Drop Detection Using Lens Position Sensing of Camera Module”, Ser. No. 12/661,756, filing date Mar. 23, 2010, and

DI08-006, titled “Camera Shutter and position control thereof”, Ser. No. 12/658,280, filing date Feb. 5, 2010,

and assigned to the common assignee of the present invention, herein incorporated by reference in their entirety.

### BACKGROUND OF THE INVENTION

(1) Field of the Invention

This invention relates generally to camera modules and relates more specifically to movable lens barrels being moved using ball bearings and a retention system is holding the lens barrel and ball bearings together even during shock conditions.

(2) Description of the Prior Art

Digital camera modules are used with many electronic devices such as e.g. mobile phones, personal data assistants (PDAs), computers, etc. These camera modules have to be as small as possible, reliable, and easy to be used, robust and require minimal power consumption. Furthermore the design of the camera modules should allow low manufacturing cost, while the quality of the images has to conform to a high standard.

Therefore modern camera modules should allow auto-focusing and minimal friction of the bearing for a movable lens barrel in order to achieve precise focusing of the camera.

There are known patents dealing with the design of camera modules.

U.S. Patent Publication (US 2008/0192363 to Shirono et al.) teaches a camera module in which a lens holder holding one or more optical lenses is movable in the direction of the optical axis and in which an auto-focus function and a zoom function are incorporated is reduced in size and weight. A bearing section is formed in the lens holder, and a drive shaft is inserted in the bearing section. An operation part of a piezo element is made to be in contact with the drive shaft.

U.S. patent (U.S. Pat. No. 5,966,551 to Haraguchi et al.) discloses a lens shutter type of camera in which a zoom lens is positioned in a lens block that has a sector gear rotatably associated with the lens block and with a rotatable cam ring. The cam ring and sector gear are rotatable in a substantially constant axial position. A movable finder optical assembly and a movable strobe assembly are movable in association with movement of the zoom lens. The zoom lens is movable between an extreme telephoto position and an extreme wide-angle position, as well as into a fully collapsed lens position beyond the extreme wide-angle position and a macro or close-up photographing position beyond the extreme telephoto position.

U.S. Patent Publication (US 2008/0075446 to Utz) describes a horological motor of the Lavet motor concept is used to form an actuator to control movement of a lens system to reduce power consumption in digital camera units used in various electronic equipment, e.g. PDA's, mobile phones, digital still cameras and camcorders, and as a result increase battery life.

### SUMMARY OF THE INVENTION

A principal object of the present invention is to achieve methods and systems to hold parts of an auto-focus camera module using ball bearings together.

A further object of the present invention is to minimize friction for moving a lens barrel of an auto-focus camera module.

A further object of the present invention is to use magnetic forces to hold parts of an auto-focus camera module using ball bearings together.

Another further object of the present invention is to hold parts of an auto-focus camera module using ball bearings together even during a mechanical shock.

Another further object of the present invention is to hold parts of an auto-focus camera module using ball bearings together by a hook during a mechanical shock.

In accordance with the objects of this invention a method to retain with minimal friction a movable part, a fixed part and ball bearings of an auto-focus camera module has been achieved. The method invented comprises the following steps: (1) providing a camera module comprising a lens barrel, holding one or more lenses, one or more actuators to move the lens barrel, ball bearings to guide the movements of the lens barrel, and a carrier, (2) deploying a permanent magnet on an inner side of the carrier and on a same side as the ball bearings, and (3) deploying a metallic inlay on a moving part of the camera module in an opposite position to the permanent magnet.

In accordance with the objects of this invention an auto-focus camera module having a precise bearing and low friction has been achieved. The camera module invented comprises, firstly: a movable lens barrel, a carrier, and one or more actuators to move the lens barrel. Furthermore the camera module comprises ball bearings between the lens barrel and the carrier to guide the movements of the lens barrel, a permanent magnet on a same side of the carrier as the ball bearings, and a metallic inlay on the lens barrel opposite to the permanent magnet.

### BRIEF DESCRIPTION OF THE DRAWINGS

In the accompanying drawings forming a material part of this description, there is shown:

FIG. 1 shows a side view of a camera module of the present invention

FIG. 2 shows the principle of the magnetic retention system of the present invention

FIG. 3 shows an implementation of the magnetic retention system in a camera module having a movable lens barrel.

FIG. 4 shows a total view of a camera module invented according to the present invention.

FIG. 5 shows a side view of the camera module invented inclusive a hook protecting the ball bearings and the lens barrel in case of a mechanical shock.

FIG. 6 illustrates a flowchart of a method invented to retain with minimal friction the movable parts, the fixed part, and the ball bearings of an auto-focus camera module, even in case of a mechanical shock.

### DESCRIPTION OF THE PREFERRED EMBODIMENTS

The preferred embodiments disclose methods and systems for auto-focus camera modules wherein ball bearings are guiding a movable lens barrel, the balls of the ball bearings are running in ball cages and an anti-creeping system is introduced in order to keep balls and cages in place in case of any shocks. In order to meet high image quality targets a very precise bearing with low friction is required.

Furthermore the present invention discloses methods and systems to retain its lens barrel and ball bearing system even in the event of a mechanical shock.

A key advantage of the present invention is that the lens barrel of the camera module can be moved with minimal friction, which is a prerequisite for meeting high quality image targets, and can be manufactured with lower costs than prior art using threads or guiding rods.

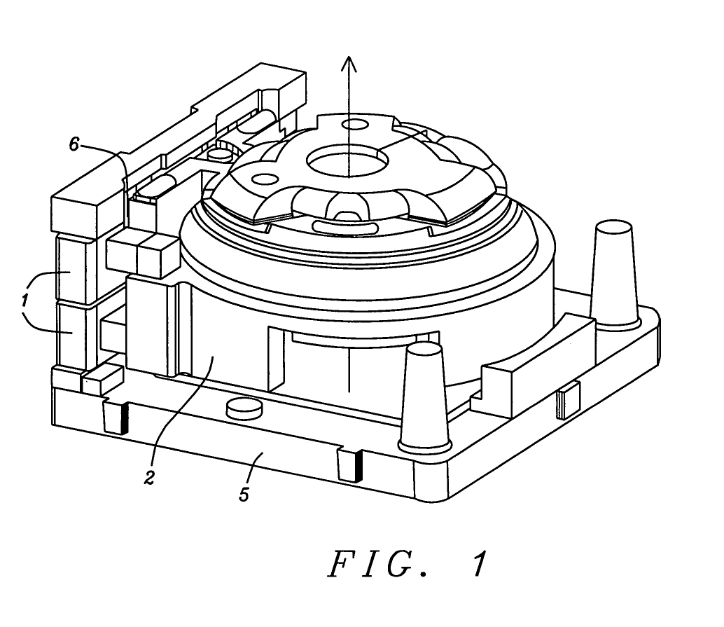

FIG. 1 shows a side view of a camera module of the present invention. It shows coils of one of the two actuators 1, the lens barrel 2, having a lens in the middle, one of two ball cages 6 of the ball bearings, and a carrier 5 of the camera module.

Bidirectional actuators, comprising coils wrapped around magnetic metal, preferably iron, and at least one permanent magnet are deployed to move the lens barrels of FIG. 1. In a preferred embodiment two of such actuators are used to move the lens barrel and the permanent magnet is mounted on the lens barrel and the iron carrying the coils is mounted on the carrier.

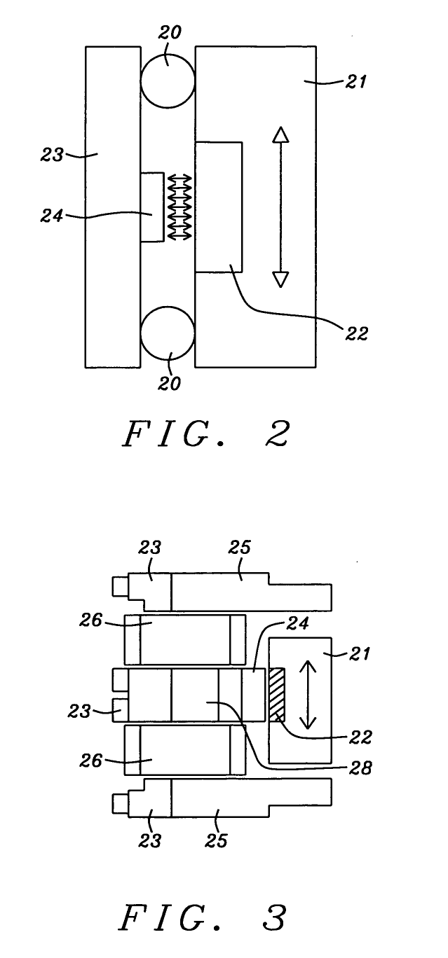

The fixed part and the movable part of camera module using ball bearings have to be held together. It is important that a retention system, holding the parts together, should cause no additional friction. In order to minimize the force for lens displacement, mechanical sources of friction need to be eliminated. The magnetic retention system of the present invention has no friction sources except the ball bearing. FIG. 2 shows the principle of the present invention.

The moving part 21, which is a part of the lens barrel of the camera module, contains a metallic inlay 22, which is attracted by a permanent magnet 24 of the fixed part 23. The only contact points between fixed part and moving part are the balls 20 of the balls bearing. The magnetic retention system invented has a minimal friction. It should be noted that the inlay 22 is longer than the permanent magnet 24 in order to ensure that the full magnetic force of the permanent magnet 24 is active on the inlay 22 independent upon any possible position of the moving part 21 of the lens barrel.

It should be noted that the permanent magnet could be deployed on the movable part and the inlay on the fixed part of the camera module as well.

FIG. 3 shows an implementation of the magnetic retention system in a camera module having a movable lens barrel. FIG. 3 shows a movable part 21, which is firmly connected to the lens barrel. The double-sided arrow indicates the directions of movement. A permanent magnet 24 is holding the parts together by magnetic force between the magnet and the metallic inlay 22. The fixed part of the camera module comprises plastic support parts 23 and parts 25, made of steel guiding a magnetic field generated by two coils 26. The magnetic field drives the movable part 21 to the desired direction, depending upon the direction of currents through the coils 26.

In FIG. 3 an embodiment using two coils 26 is shown, alternatively only one coil could be used as well. It should be noted that the inlay 22 would not be required if the movable part comprises magnetic material, e.g. iron. The balls and ball cage of the ball bearings have been omitted intentionally in order to avoid unnecessary complexity of the drawing.

Alternatively the attraction force of the permanent magnet can be adjusted more precisely by placing a second permanent magnet on the moving part instead of a metallic inlay. This attraction force defines the pre-load of the ball bearing. In this case should the permanent magnet on the movable part be in the direction of movement longer than the permanent magnet on the fixed part, or the magnet on the fixed part should be long enough that in any position of the movable part sufficient magnetic attraction is ensured.

A second feature of the present invention comprises a means to the parts together in case of a mechanical shock. The magnetic force my not be strong enough to hold the parts together in case of a shock condition. A hook or a screw holds the lens barrel to the carrier in this case. In normal operation, i.e. if there is no shock condition, there is no friction of the hook since it does not touch the carrier.

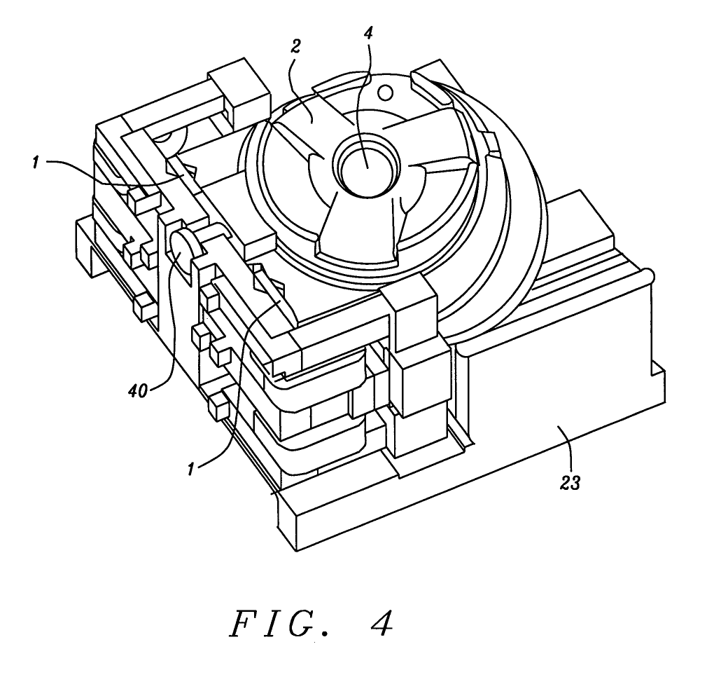

FIG. 4 shows a total view of a camera module invented according to the present invention. FIG. 4 shows a hook/screw 40 deployed to hold the parts of the camera module together in case of a mechanical shock. Furthermore FIG. 4 shows a lens barrel 2, a lens 4, ball bearings 1, and a carrier 23 of the camera module. The hook/screw 40 touches the movable part of the camera module only in case of a mechanical shock and prevents e.g. that the ball bearings 1 derail. Under normal conditions the hook/screw 40 does not touch the movable part of the camera module.

FIG. 5 shows a side view of the camera module invented inclusive the hook 40 protecting the ball bearings and the lens barrel in case of a mechanical shock. Furthermore FIG. 5 shows a fixed part 23, the movable part 21, being firmly connected with the lens barrel, of the camera module, and the balls 20, each provided with ball cages 50, of the ball bearings The double arrow illustrates the directions of movement of the movable part 21. The hook 40 can be adjusted like a screw. In a preferred embodiment a lid 41, which can be glued, secures the hook 40. In another embodiment a screw is used instead of a hook.

Alternative embodiments are possible as well. Instead of a hook a screw is deployed that is mounted on the movable part of the camera module, moving together during normal conditions. Another alternative is to deploy a rib, i.e. a kind of wall, on the fixed part of the camera opposite to the ball bearing.

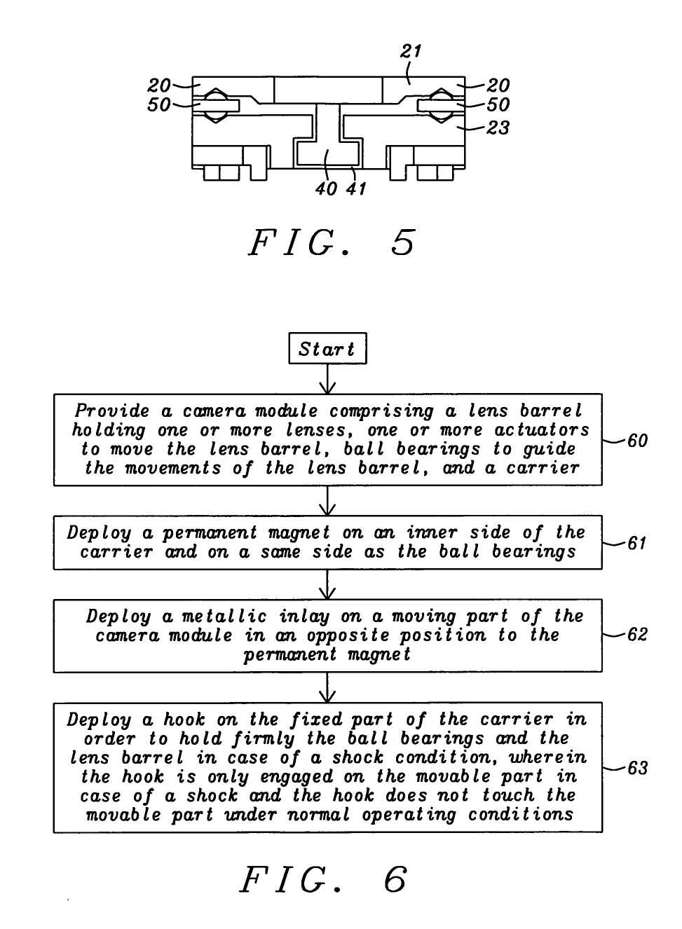

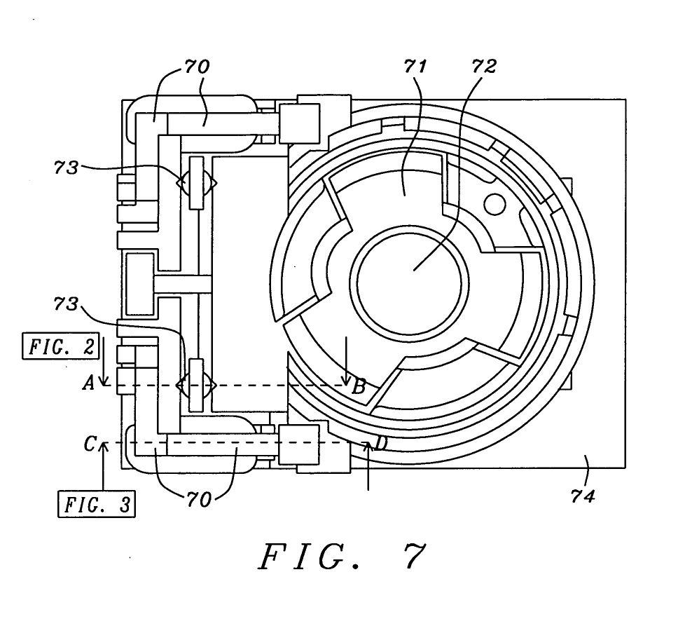

FIG. 6 illustrates a flowchart of a method invented to retain with minimal friction the movable parts, the fixed part, and the ball bearings of an auto-focus camera module, even in case of a mechanical shock. A first step 60 describes the provision of a camera module comprising a lens barrel, holding one or more lenses, one or more actuators to move the lens barrel, ball bearings to guide the movements of the lens barrel, and a carrier. The next step 61 illustrates deploying a permanent magnet on an inner side of the carrier and on a same side as the ball bearings. The following step 62 describes deploying a metallic inlay on a moving part of the camera module in an opposite position to the permanent magnet. It should be noted that alternatively the permanent magnet and the inlay could also be deployed vice versa, i.e. the permanent magnet on the moving part of the camera and correspondently the metallic inlay could be deployed on an inner side of the carrier. Furthermore the metallic inlay could be replaced by a second permanent magnet. Step 63 describes deploying a hook/screw on the fixed part of the carrier in order to hold firmly the ball bearings and the lens barrel in case of a shock condition, wherein the hook/screw is only engaged on the movable part in case of a shock and the hook/screw does not touch the movable part under normal operating conditions. Furthermore the hook/screw could alternatively be deployed on the movable part of the camera module engaging on the fixed part, i.e. the carrier, in case of a shock.

While the invention has been particularly shown and described with reference to the preferred embodiments thereof, it will be understood by those skilled in the art that various changes in form and details may be made without departing from the spirit and scope of the invention.

What is claimed is:

1. A method to retain with minimal friction a movable part, a fixed part and ball bearings of an auto-focus camera module, comprising the following steps:
(1) providing a camera module comprising a lens barrel, holding one or more lenses, one or more actuators to move the lens barrel along an optical axis of the camera module, ball bearings to guide the movements of the lens barrel, and a carrier;
(2) deploying a permanent magnet on an inner side of the carrier;
(3) deploying a metallic inlay on a moving part of the camera module in an opposite position to the permanent magnet; and
(4) deploying balls of the ball bearing as only contact point between the moving part and the carrier.

2. The method of claim 1 comprising a step of deploying a hook on the fixed part of the carrier in order to hold firmly the ball bearings and the lens barrel in case of a shock condition, wherein the hook is only engaged on the movable part in case of a shock and the hook does not touch the movable part under normal operating conditions.

3. The method of claim 2 wherein said hook can be adjusted like a screw.

4. The method of claim 1 comprising a step of deploying a hook on the movable part of the carrier in order to hold firmly the ball bearings and the lens barrel in case of a shock condition, wherein the hook is only engaged on the fixed part in case of a shock and the hook does not touch the fixed part under normal operating conditions.

5. The method of claim 4 wherein said hook can be adjusted like a screw.

6. The method of claim 1 wherein said inlay on the movable part is longer in the direction of movement than the permanent magnet on the fixed part.

7. The method of claim 1 wherein said inlay is replaced by a second permanent magnet.

8. The method of claim 1 wherein said permanent magnet is deployed on the moving part of the camera module in an opposite position to the inlay and said inlay is deployed on said inner side of the carrier and on the same side as the ball bearings.

9. The method of claim 8 wherein said permanent magnet on the movable part of the camera module is in regard of a direction of movement longer than the inlay on the fixed part of the camera module.

10. The method of claim 8 wherein said inlay is replaced by a second permanent magnet.

11. The method of claim 1 wherein the balls of the bearings are the only contact points between the fixed part and the moving part.

12. An auto-focus camera module having a precise bearing and low friction, comprises:
a lens barrel movable along an optical axis of the camera module;
a carrier;
an image sensor;
one or more actuators to move the lens barrel along the optical axis;
ball bearings between the lens barrel and the carrier to guide the movements of the lens barrel;
a permanent magnet arranged on an inner side of the carrier; and
a metallic inlay on the lens barrel opposite to the permanent magnet.

13. The camera module of claim 12 wherein a hook is deployed on the carrier on a same side as the ball bearings in order to hold firmly the ball bearings and the lens barrel in case of a shock condition, wherein the hook is only engaged on the movable lens barrel in case of a shock and the hook does not touch the movable lens barrel under normal operating conditions.

14. The camera module of claim 13 wherein said hook can be adjusted like a screw.

15. The camera module of claim 12 wherein a hook is deployed on the movable part of the carrier in order to hold firmly the ball bearings and the lens barrel in case of a shock condition, wherein the hook is only engaged on the fixed part in case of a shock and the hook does not touch the fixed part under normal operating conditions.

16. The camera module of claim 15 wherein said hook can be adjusted like a screw.

17. The camera module of claim 12 wherein said inlay on the movable part is longer in the direction of movement than the permanent magnet on the fixed part.

18. The camera module of claim 12 wherein said inlay is replaced by a second permanent magnet.

19. The camera module of claim 12 wherein said permanent magnet is deployed on the moving part of the camera module in an opposite position to the inlay and said inlay is deployed on said inner side of the carrier and on the same side as the ball bearings.

20. The camera module of claim 19 wherein said permanent magnet on the movable part of the camera module is in regard of a direction of movement longer than the inlay on the fixed part of the camera module.

21. The camera module of claim 19 wherein said inlay is replaced by a second permanent magnet.

22. The camera module of claim 12 wherein the balls of the bearings are the only contact points between the fixed part and the moving part.
